(19) United States
(12) Patent Application Publication
(10) Pub. No.: US 2025/0002760 A1
(43) Pub. Date: Jan. 2, 2025

(54) ADHESIVE SHEET

(71) Applicant: LINTEC CORPORATION, Tokyo (JP)

(72) Inventor: Toshiaki NAGASAWA, Saitama-shi, Saitama (JP)

(73) Assignee: LINTEC CORPORATION, Tokyo (JP)

(21) Appl. No.: 18/711,168

(22) PCT Filed: Nov. 22, 2021
(86) PCT No.: PCT/JP2021/042732

§ 371 Date: May 17, 2024

(51) Int. Cl. C09J 7/40; C09J 5/06; C09J 121/00

(52) U.S. Cl. CPC C09J 7/401; C09J 5/06; C09J 121/00; C09J 2301/122; C09J 2301/302; C09J 2301/304; C09J 2400/16; C09J 2421/00; C09J 2423/005; C09J 2467/005; C09J 2467/006; C09J 2475/005

(57) ABSTRACT

A pressure sensitive adhesive sheet including a base material, a metallized layer, and a rubber-based hot-melt pressure sensitive adhesive layer in this order, the pressure sensitive adhesive sheet further including a coating layer disposed between the metallized layer and the rubber-based hot-melt pressure sensitive adhesive layer and containing a polyester-based resin.

### TECHNICAL FIELD

The present invention relates to a pressure sensitive adhesive sheet.

### BACKGROUND ART

Pressure sensitive adhesives exhibit excellent performance such as flexibility, elasticity, and pressure sensitive adhesion and have been widely used for applications in pressure sensitive adhesive sheets. A production method for such a pressure sensitive adhesive generally involves a solvent process in which a material such as rubber is dissolved in a solvent, the solution is applied onto a base material, and then the solvent is dried by heating; however, the production method involving this solvent process poses a problem that a long time is required for dissolution of the material such as rubber in the solvent.

Therefore, in recent years, a hot-melt pressure sensitive adhesive that can be applied onto a base material by heating and melting is suitably used (e.g., see Patent Documents 1 and 2).

### CITATION LIST

### Patent Document

Patent Document 1: JP 2017-179240 A
Patent Document 2: JP 7-278509 A

### SUMMARY OF INVENTION

### Technical Problem

In some cases, a hot-melt pressure sensitive adhesive layer that can be applied onto a base material by heating and melting is formed on the base material by interposing a metallized layer between the hot-melt pressure sensitive adhesive layer and the base material. That is, the metallized layer may be provided between the base material and the hot-melt pressure sensitive adhesive layer. Because the surface of the metallized layer is highly smooth, in many cases, a problem occurs in the interlayer adhesion between the base material and the hot-melt pressure sensitive adhesive layer due to difficulty in achieving adhesion between the metallized layer and the hot-melt pressure sensitive adhesive layer. In particular, a pressure sensitive adhesive sheet including a hot-melt pressure sensitive adhesive layer formed by using a rubber-based pressure sensitive adhesive may cause a problem due to low interlayer adhesion between the base material and the hot-melt pressure sensitive adhesive layer. Specifically, when the pressure sensitive adhesive sheet is peeled from an adherend, the adhesive sheet may cause a problem that the pressure sensitive adhesive remains on the adherend, that is, adhesive residue occurs.

The present invention has been made to solve the problems described above, and an object of the present invention is to provide a pressure sensitive adhesive sheet that suppresses occurrence of adhesive residue at the time of peeling and that includes a metallized layer and a rubber-based hot-melt pressure sensitive adhesive layer.

### Solution to Problem

The present inventors have found that the problems described above can be solved by providing a coating layer containing a polyester-based resin between a metallized layer and the rubber-based hot-melt pressure sensitive adhesive layer, and thus have completed the present invention.

Accordingly, the present invention provides the following [1] to [7].

[1] A pressure sensitive adhesive sheet including a base material, a metallized layer, and a rubber-based hot-melt pressure sensitive adhesive layer in this order, the pressure sensitive adhesive sheet further including a coating layer disposed between the metallized layer and the rubber-based hot-melt pressure sensitive adhesive layer and containing a polyester-based resin.

[2] The pressure sensitive adhesive sheet according to [1] above, wherein the coating layer further contains at least one of a polyurethane-based resin or a polyolefin-based resin.

[3] The pressure sensitive adhesive sheet according to [1] or [2] above, wherein the metallized layer is an aluminum-deposited layer.

[4] The pressure sensitive adhesive sheet according to any one of [1] to [3] above, wherein the base material is a resin film containing a polyester-based resin.

[5] The pressure sensitive adhesive sheet according to any one of [1] to [4] above, wherein the polyester-based resin contained in the coating layer has a glass transition temperature of from 20 to 80° C.

[6] The pressure sensitive adhesive sheet according to any one of [1] to [5] above, further including a release liner on the rubber-based hot-melt pressure sensitive adhesive layer on a side opposite to the coating layer.

[7] A method for producing a pressure sensitive adhesive sheet,
the pressure sensitive adhesive sheet including a base material, a metallized layer, a coating layer containing a polyester-based resin, and a rubber-based hot-melt pressure sensitive adhesive layer in this order,
the method including forming a coating layer by application of a coating liquid having a pH of 5 or higher and 9 or lower.

### Advantageous Effects of Invention

The present invention can provide a pressure sensitive adhesive sheet that suppresses occurrence of adhesive residue at the time of peeling and that includes a metallized layer and a rubber-based hot-melt pressure sensitive adhesive layer.

### BRIEF DESCRIPTION OF DRAWINGS

FIG. 1 is a cross-sectional view illustrating a structure of a pressure sensitive adhesive sheet according to a first embodiment of the present invention.

FIG. 2 is a cross-sectional view illustrating a structure of a pressure sensitive adhesive sheet according to a second embodiment of the present invention.

### DESCRIPTION OF EMBODIMENTS

In the present specification, the “weight average molecular weight” is a value measured by gel permeation chromatography (GPC) in terms of polystyrene.

Furthermore, lower limits and upper limits described in a stepwise manner for preferred numerical ranges (e.g., a range of content) can be combined independently. For example, based on the description “preferably from 10 to 90, more preferably from 30 to 60”, the “preferred lower limit (10)” and the “preferred upper limit (60)” can be combined as “from 10 to 60”.

In the present specification, “adhesive residue” refers to a phenomenon in which a pressure sensitive adhesive remains on an adherend when a pressure sensitive adhesive sheet is peeled from the adherend.

### Configuration of Pressure Sensitive Adhesive Sheet

The pressure sensitive adhesive sheet according to an embodiment of the present invention includes a base material, a metallized layer, and a rubber-based hot-melt pressure sensitive adhesive layer (hereinafter may be referred to simply as “hot-melt pressure sensitive adhesive layer”) in this order. The pressure sensitive adhesive sheet according to an embodiment of the present invention further includes a coating layer disposed between the metallized layer and the rubber-based hot-melt pressure sensitive adhesive layer and containing a polyester-based resin.

The configuration of the pressure sensitive adhesive sheet is not particularly limited as long as the adhesive sheet includes a coating layer containing a polyester-based resin between a metallized layer and a hot-melt pressure sensitive adhesive layer. The coating layer is a layer provided for the purpose of suppressing occurrence of adhesive residue at the time of peeling, that is, suppressing remaining of the pressure sensitive adhesive on an adherend.

The pressure sensitive adhesive sheet according to an embodiment of the present invention may include an additional layer between the base material and the metallized layer; however, from the perspective of further suppressing occurrence of adhesive residue at the time of peeling, the adhesive sheet preferably has a structure including the base material, the metallized layer, the coating layer, and the hot-melt pressure sensitive adhesive layer in this order without interposing an additional layer.

In the pressure sensitive adhesive sheet according to an embodiment of the present invention, a release liner may be provided on the hot-melt pressure sensitive adhesive layer on the side opposite to the coating layer, and a printed coating layer may be provided on the base material on the side opposite to the coating layer.

The pressure sensitive adhesive sheet according to an embodiment of the present invention may include an additional layer that does not correspond to the base material, the metallized layer, the coating layer, the hot-melt pressure sensitive adhesive layer, the release liner, and the printed coating layer described above.

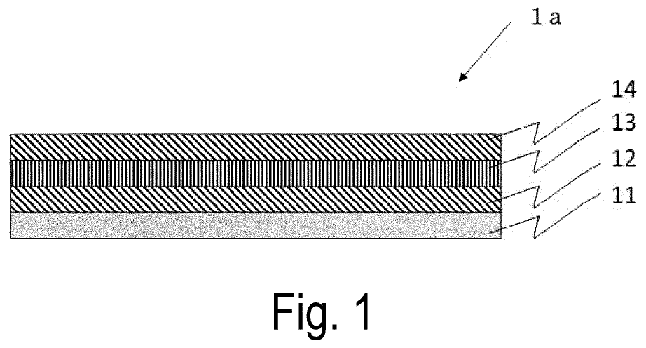

FIG. 1 is a cross-sectional view illustrating a structure of a pressure sensitive adhesive sheet according to a first embodiment of the present invention.

In a pressure sensitive adhesive sheet 1a according to the first embodiment of the present invention, a metallized layer 12 is provided on one surface of a base material 11, a coating layer 13 is provided on the metallized layer 12, and a hot-melt pressure sensitive adhesive layer 14 is provided on the coating layer 13.

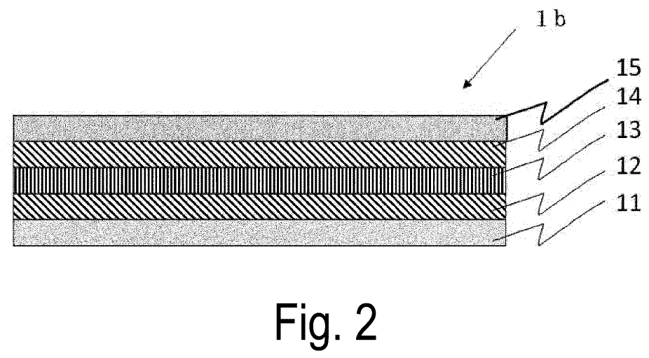

FIG. 2 is a cross-sectional view illustrating a structure of a pressure sensitive adhesive sheet according to a second embodiment of the present invention.

In a pressure sensitive adhesive sheet 1b according to the first embodiment of the present invention, a metallized layer 12 is provided on one surface of a base material 11, a coating layer 13 is provided on the metallized layer 12, a hot-melt pressure sensitive adhesive layer 14 is provided on the coating layer 13, and a release liner 15 is provided on the hot-melt pressure sensitive adhesive layer 14.

Each of the layers constituting the pressure sensitive adhesive sheet according to an embodiment of the present invention will be described below.

### Coating Layer

The coating layer contains a polyester-based resin. Since the coating layer contains the polyester-based resin, there can be provided a pressure sensitive adhesive sheet that suppresses occurrence of adhesive residue at the time of peeling and that includes a metallized layer and a rubber-based hot-melt pressure sensitive adhesive layer. It is not known why such an effect is achieved; however, the reason is conceived as follows.

The polyester-based resin has a polar group, such as an ester group. It is conceived that, when such a polar group is contained, good adhesion is achieved between the metallized layer and the coating layer containing the polyester-based resin. Meanwhile, the polyester-based resin is a hydrophobic resin containing a hydrophobic group. Thus, it is conceived that adhesion between the hot-melt pressure sensitive adhesive layer containing a rubber component and the coating layer containing the polyester-based resin is adequately ensured. That is, it is conceived that, because adhesion between the metallized layer and the coating layer and between the coating layer and the pressure sensitive adhesive layer is adequately ensured, remaining of the hot-melt pressure sensitive adhesive layer on an adherend (occurrence of adhesive residue) can be suppressed when the pressure sensitive adhesive sheet is peeled.

From the perspectives of further suppressing occurrence of adhesive residue and, especially, suppressing occurrence of adhesive residue also when peeling is performed at a high speed of approximately 30 m/min, the coating layer preferably further contains at least one of a polyurethane-based resin or a polyolefin-based resin besides the polyester-based resin. As necessary, the coating layer may contain an additional resin besides a polyester-based resin, a polyurethane-based resin, and a polyolefin-based resin, a cross-linking agent, and an additional additive.

The thickness of the coating layer is not particularly limited; however, from the perspective of interlayer adhesion between the coating layer and the hot-melt pressure sensitive adhesive layer, the thickness is preferably 0.01 μm or greater, more preferably 0.2 μm or greater, and particularly preferably 0.3 μm or greater, and preferably 10 μm or less, more preferably 5 μm or less, and particularly preferably 2 μm or less.

The thickness of the coating layer is specifically a value measured and calculated on the basis of the method described in the Examples below.

The method of forming the coating layer is not particularly limited; however, from the perspectives of effects on environment as well as safety during application such as prevention of ignition accident due to static electricity, the method preferably includes a step of applying an aqueous coating liquid containing a polyester-based resin to the base material. The polyester-based resin in the aqueous coating liquid may be in a form dispersed in water or may be in a dissolved form; however, a dispersed form is preferred. That is, the coating layer is preferably a layer formed by applying an aqueous resin dispersion, in which a polyester-based resin is dispersed in water, to a base material. In a case where the coating layer further contains at least one of a polyurethane-based resin or a polyolefin-based resin, a step of applying an aqueous coating liquid containing the polyester-based resin and at least one of the polyurethane-based resin or the polyolefin-based resin to the base material is preferably included. The polyester-based resin, the polyurethane-based resin, and the polyolefin-based resin in the aqueous coating liquid may be in a form dispersed in water or may be in a dissolved form; however, a dispersed form is preferred. That is, the coating layer is preferably a layer formed by application of an aqueous resin dispersion, in which a polyester-based resin and at least one of a polyurethane-based resin or a polyolefin-based resin are dispersed in water, onto a base material.

The aqueous resin dispersion refers to a dispersion containing water as a main component and contains not less than 50 mass % of water.

The aqueous coating liquid may contain a solvent described in “method for producing pressure sensitive adhesive sheet” below. However, preferably, the aqueous coating liquid does not contain such a solvent.

### Polyester-Based Resin

The polyester-based resin contained in the coating layer is not particularly limited, but is typically a resin having an ester bond in a main chain.

From the perspective of suppressing occurrence of adhesive residue, the polyester-based resin contained in the coating layer is preferably at least one of a polyester resin or a modified polyester resin, and is more preferably a polyester resin.

The glass transition temperature of the polyester-based resin is not particularly limited and, from the perspective of suppressing occurrence of adhesive residue, the glass transition temperature is preferably 20° C. or higher, more preferably 25° C. or higher, even more preferably 30° C. or higher, and particularly preferably 35° C. or higher, and from the perspective of coating formability, preferably 80° C. or lower, more preferably 75° C. or lower, even more preferably 70° C. or lower, and particularly preferably 65° C. or lower. When the glass transition temperature is 20° C. or higher, an excellent effect of suppressing occurrence of adhesive residue can be achieved, and when the glass transition temperature is 80° C. or lower, defects are less likely to occur, and a coating is readily formed.

The glass transition temperature of the polyester-based resin is a value measured and calculated on the basis of the method described in the Examples below.

The hydroxyl value of the polyester-based resin is not particularly limited, but is preferably 0.5 KOHmg/g or greater, more preferably 1 KOHmg/g or greater, and particularly preferably 2 KOHmg/g or greater, and preferably 10 KOHmg/g or less, more preferably 9 KOHmg/g or less, and particularly preferably 8 KOHmg/g or less.

The hydroxyl value of the polyester-based resin is a value measured and calculated on the basis of the method described in the Examples below.

The acid value of the polyester-based resin is not particularly limited, but is preferably 20 KOHmg/g or greater, more preferably 30 KOHmg/g or greater, and particularly preferably 40 KOHmg/g or greater, and preferably 80 KOHmg/g or less, more preferably 70 KOHmg/g or less, and particularly preferably 60 KOHmg/g or less.

The acid value of the polyester-based resin is a value measured and calculated on the basis of the method described in the Examples below.

The number average molecular weight Mn of the polyester-based resin is not particularly limited, but is preferably 1,000 or greater, and more preferably 2,000 or greater, and preferably 1,0000 or less, and more preferably 5000 or less.

The content of the polyester-based resin in the coating layer is not particularly limited and, in a case where the below-described polyurethane-based resin and the polyolefin-based resin are not contained, the content is preferably 80 mass % or greater, more preferably 90 mass % or greater, even more preferably 95 mass % or greater, and particularly preferably substantially 100 mass %. In addition to the polyester-based resin, in a case where at least one of the polyurethane-based resin or the polyolefin-based resin described below is further contained, the content of the polyester-based resin in the coating layer is preferably 40 mass % or greater, more preferably 45 mass % or greater, even more preferably 48 mass % or greater, and particularly substantially 50 mass %.

### Polyester Resin

The polyester resin is a copolymer obtained by a polycondensation reaction between an acid component and a diol component or a polyol component.

The polycondensation reaction is performed by an ordinary polyesterification reaction such as a direct esterification method or a transesterification method.

One type of these polyester resins may be used alone, or a combination of two or more types of these polyester resins may be used.

Examples of the acid component include aromatic dicarboxylic acids, such as terephthalic acid, phthalic acid, sulfoterephthalic acid, isophthalic acid, phthalic anhydride, α-naphthalenedicarboxylic acid, 2,6-naphthalenedicarboxylic acid, 5-sodium sulfoisophthalic acid, 5-potassium sulfoisophthalic acid, or anhydrides or esters of these; aliphatic dicarboxylic acids, such as pimelic acid, suberic acid, azelaic acid, oxalic acid, sebacic acid, succinic acid, adipic acid, undecylenic acid, dodecanedicarboxylic acid, or anhydrides or esters of these; and alicyclic dicarboxylic acids, such as 1,3-cyclohexanedicarboxylic acid, 1,3-cyclopentanedicarboxylic acid, 1,2-cyclohexanedicarboxylic acid, 1,2-cyclopentanedicarboxylic acid, 1,4-cyclohexanedicarboxylic acid, or anhydrides or esters of these. One of these may be used alone, or two or more may be used in combination.

Examples of the diol component or the polyol component include aliphatic glycols, such as ethylene glycol, 1,2-propylene glycol, 1,3-propylene glycol, 1,3-butanediol, 1,4-butanediol, 1,5-pentanediol, 1,6-hexanediol, 1,8-octanediol, 1,9-nonanediol, neopentyl glycol, 3-methylpentanediol, 2,2,3-trimethylpentanediol, diethylene glycol, triethylene glycol, and dipropylene glycol; alicyclic glycols, such as 1,2-cyclohexanediol, 1,2-cyclohexanedimethanol, 1,4-cyclohexanediol, and 1,4-cyclohexanedimethanol; and aromatic glycols, such as p-xylene glycol and bisphenol A. One of these may be used alone, or two or more may be used in combination.

The polyester resin may contain a reactive functional group.

Specific examples of the reactive functional group include a hydroxyl group, a carboxyl group, and an amino group.

The reactive functional group may be a group responsible for a polymerization reaction (i.e., responsible for main chain formation) or may be a group provided additionally. In the polyester-based resin, a constitutional unit of polyol may have a hydroxyl group or a constitutional unit of a carboxylic acid component may have a carboxylic acid, and a residual hydroxyl group or residual carboxylic acid of these may be the reactive functional group described above.

The polyester resin may contain an active energy beam-polymerizable functional group. The polyester resin having such a structure can be produced by, for example, in a stage at which a polymerization reaction is performed to form a polyester-based resin, allowing a monomer and/or an oligomer (hereinafter may be referred to as “monomer and the like”) to coexist with a compound having an active energy beam-polymerizable functional group and causing a reaction between this compound and the monomer and the like together with a polymerization reaction of the monomer and the like to introduce this compound into a skeleton of the polyester-based resin. In the present specification, “active energy beam” refers to a beam having an energy quantum among electromagnetic waves or charged particle radiation, i.e., refers to an active light such as ultraviolet rays or an electron beam.

### Modified Polyester Resin

The modified polyester resin is not particularly limited as long as the modified polyester resin is obtained by modification of the polyester resin described above, and examples thereof include urethane-modified polyester resins, acrylic-modified polyester resins, and silicone-modified polyester resins. One of these may be used alone, or two or more may be used in combination.

Examples of the urethane-modified polyester resin include a polyester resin further containing a urethane bond. The urethane-modified polyester resin can be obtained by, for example, reacting a polyisocyanate compound with a polyester resin having two or more functional groups such as hydroxy groups per molecule.

Specific examples of the urethane-modified polyester resin include polymers (polyesterurethane) obtained by reacting a polyester polyol with any polyisocyanate compound, the polyester polyol having a hydroxyl group at a terminal of a copolymer obtained by a polycondensation reaction between the acid component and the diol component or the polyol component described above.

The polyisocyanate compound used in urethane modification of the polyester resin is preferably a polyisocyanate compound having two or more isocyanate groups per molecule.

Examples of the polyisocyanate compound having two or more isocyanate groups per molecule include diisocyanate compounds, triisocyanate compounds, tetraisocyanate compounds, pentaisocyanate compounds, and hexaisocyanate compounds. More specifically, examples include aromatic polyisocyanate compounds, such as tolylene diisocyanate, diphenylmethane diisocyanate, and xylylene diisocyanate; alicyclic isocyanate compounds, such as dicyclohexylmethane-4,4-diisocyanate, bicycloheptane triisocyanate, cyclopentylene diisocyanate, cyclohexylene diisocyanate, methylcyclohexylene diisocyanate, and hydrogenated xylylene diisocyanate; and aliphatic isocyanate compounds, such as pentamethylene diisocyanate, hexamethylene diisocyanate, heptamethylene diisocyanate, trimethylhexamethylene diisocyanate, and lysine diisocyanate. One of these may be used alone, or two or more may be used in combination.

In addition, modified products of these isocyanate compounds can also be used, including biuret products or isocyanurate products, or adducts that are reaction products of these isocyanate compounds with a non-aromatic low molecular weight active hydrogen-containing compound, such as ethylene glycol, trimethylolpropane, or castor oil.

The urethane-modified polyester resin is preferably a urethane-modified polyester resin having a basic structure of aromatic polyester. The basic structure of aromatic polyester has a repeating unit derived from an aromatic compound in a polyester structure of a main chain and is obtained, for example, when one or both of dicarboxylic acid and glycol compounds of some or all of copolymer raw materials are aromatic compound(s).

### Polyurethane-Based Resin

From the perspective of further suppressing occurrence of adhesive residue, the coating layer preferably contains a polyurethane-based resin.

When the coating layer contains the polyurethane-based resin, the polarity of the coating layer decreases and adhesion between the coating layer and the pressure sensitive adhesive layer is improved, and thus occurrence of adhesive residue especially at the time of high-speed peeling can be further suppressed.

The polyurethane-based resin is not particularly limited, but typically is a resin obtained by reacting a polyisocyanate component and a polyol component and, as needed, is subjected to chain extension in the presence of a chain extender, which is a low molecular weight compound having two or more active hydrogens, such as a diol or a diamine.

The glass transition temperature of the polyurethane-based resin is not particularly limited and, from the perspective of suppressing occurrence of adhesive residue, the glass transition temperature is preferably 40° C. or higher, more preferably 60° C. or higher, even more preferably 70° C. or higher, and particularly preferably 80° C. or higher, and from the perspective of coating formability, preferably 130° C. or lower, more preferably 110° C. or lower, even more preferably 100° C. or lower, and particularly preferably 90° C. or lower. When the glass transition temperature is 40° C. or higher, an excellent effect of suppressing occurrence of adhesive residue can be achieved, and when the glass transition temperature is 130° C. or lower, defects are less likely to occur, and a coating is readily formed. The glass transition temperature of the polyurethane-based resin is a value measured and calculated on the basis of the method described in the Examples below.

The acid value of the polyurethane-based resin is not particularly limited, but is preferably 1 KOHmg/g or greater, more preferably 5 KOHmg/g or greater, and particularly preferably 8 KOHmg/g or greater, and preferably 50 KOHmg/g or less, more preferably 40 KOHmg/g or less, and particularly preferably 30 KOHmg/g or less.

The acid value of the polyurethane-based resin is a value measured and calculated on the basis of the method described in the Examples below.

The number average molecular weight Mn of the polyurethane-based resin is not particularly limited, but is preferably 1,000 or greater, and more preferably 2,000 or greater, and preferably 1,000,000 or less, and more preferably 500,000 or less.

The content of the polyurethane-based resin in the coating layer is not particularly limited, but is preferably 40 mass % or greater, more preferably 45 mass % or greater, even more preferably 48 mass % or greater, and particularly preferably 50 mass %.

The polyisocyanate component is not particularly limited, but is preferably an aliphatic polyisocyanate from the perspective of suppressing occurrence of adhesive residue.

Examples of the aliphatic polyisocyanate include chain aliphatic polyisocyanates and cyclic aliphatic polyisocyanates.

Examples of the chain aliphatic polyisocyanate include trimethylene diisocyanate, 1,2-propylene diisocyanate, butylene diisocyanate (tetramethylene diisocyanate, 1,2-butylene diisocyanate, 2,3-butylene diisocyanate, 1,3-butylene diisocyanate), 1,5-pentamethylene diisocyanate (PDI), 1,6-hexamethylene diisocyanate (HDI), 2,4,4- or 2,2,4-trimethylhexamethylene diisocyanate, and 2,6-diisocyanatomethyl caprate. Among these, HDI is preferred.

Examples of the cyclic aliphatic polyisocyanate include 1,3-cyclopentane diisocyanate, 1,3-cyclopentene diisocyanate, cyclohexane diisocyanate (1,4-cyclohexane diisocyanate, 1,3-cyclohexane diisocyanate), 3-isocyanatomethyl-3,5,5-trimethylcyclohexyl isocyanate (IPDI), methylenebis(cyclohexyl isocyanate) (4,4′-, 2,4′-, or 2,2′-methylenebis(cyclohexyl isocyanate) and trans, trans-form, trans,cis-form, and cis, cis-form of these, or mixtures of these) (H₁₂MDI), methylcyclohexane diisocyanate (methyl-2,4-cyclohexane diisocyanate, methyl-2,6-cyclohexane diisocyanate), norbornane diisocyanate (various isomers or mixtures of these) (NBDI), and 1,3- and 1,4-bis(isocyanatomethyl)cyclohexane (H₆XDI) (also known as hydrogenated xylylene diisocyanate). Among these, IPDI is particularly preferred.

Examples of the polyol component include polyether polyol, polyester polyol, and polycarbonate polyol.

Examples of the polyether polyol include those obtained by ring-opening homopolymerization or ring-opening copolymerization of an alkylene oxide (e.g., an alkylene oxide having from 2 to 5 carbons, such as ethylene oxide, propylene oxide, butylene oxide, tetrahydrofuran, 3-methyltetrahydrofuran, or an oxetane compound) using a low molecular weight polyol as an initiator. Specific examples thereof include polyoxyethylene glycol, polyoxypropylene glycol, polyoxyethylene-propylene copolymers, and polyoxytetramethylene glycol (polytetramethylene ether glycol).

The low molecular weight polyol is, for example, a low molecular weight polyol having two or more hydroxyl groups and having a molecular weight of 60 to 400, and examples thereof include low molecular weight diols, such as ethylene glycol, propanediol, 1,4-butylene glycol (1,4-butanediol), 1,6-hexanediol, 1,2-butylene glycol, 1,3-butylene glycol, 1,5-pentanediol, 3-methyl-1,5-pentanediol, neopentyl glycol, alkane (having from 7 to 22 carbons)diol, diethylene glycol, triethylene glycol, dipropylene glycol, cyclohexane dimethanol, alkane-1,2-diol (having from 17 to 20 carbons), 1,4-dihydroxy-2-butene, 2,6-dimethyl-1-octene-3,8-diol, bis(hydroxyethoxy)benzene, xylene glycol, and bis(hydroxyethylene) terephthalate; low molecular weight triols, such as glycerin, 2-methyl-2-hydroxymethyl-1,3-propanediol, 2,4-dihydroxy-3-hydroxymethylpentane, 1,2,6-hexanetriol, trimethylolpropane, 2,2-bis(hydroxymethyl)-3-butanol, and other aliphatic triols (having from 8 to 24 carbons); and low molecular weight polyols having 4 or more hydroxyl groups, such as tetramethylolmethane, D-sorbitol, xylitol, D-mannitol, and D-mannite.

The polyester polyol can be obtained by a known esterification reaction, i.e., a condensation reaction of a polyhydric alcohol and a polybasic acid, or a transesterification reaction of a polyhydric alcohol and an alkyl ester of a polybasic acid. Examples of the polybasic acid or the alkyl ester thereof include aliphatic dicarboxylic acids, such as adipic acid, sebacic acid, succinic acid, azelaic acid, dimer acid, and dodecanedioic acid; alicyclic dicarboxylic acids, such as hexahydrophthalic acid and tetrahydrophthalic acid; aromatic dicarboxylic acids, such as isophthalic acid, terephthalic acid, ortho-phthalic acid, and naphthalenedicarboxylic acid; dialkyl esters of these (e.g., alkyl esters having from 1 to 6 carbons), acid anhydrides of these, and mixtures of these.

### Polyolefin-Based Resin

From the perspective of further suppressing occurrence of adhesive residue, the coating layer preferably contains a polyolefin-based resin. When the coating layer contains the polyolefin-based resin, the polarity of the coating layer decreases and adhesion between the coating layer and the pressure sensitive adhesive layer is improved, and thus occurrence of adhesive residue especially at the time of high-speed peeling can be further suppressed.

The polyolefin-based resin contained in the coating layer is not particularly limited and is typically a homopolymer of an olefin compound or a copolymer of an olefin compound and another compound.

The softening point of the polyolefin resin contained in the coating layer is not particularly limited; however, from the perspective of suppression of occurrence of adhesive residue, the softening point is preferably 0° C. or higher, more preferably 20° C. or higher, even more preferably 25° C. or higher, and particularly preferably 30° C. or higher and, from the perspective of coating formability, preferably 100° C. or lower, more preferably 60° C. or lower, even more preferably 55° C. or lower, and particularly preferably 50° C. or lower. When the softening point is lower than 0° C., a better effect of suppressing occurrence of adhesive residue can be achieved, and when the glass transition temperature is higher than 100° C., defects are less likely to occur, and a coating is more readily formed.

The softening point is a value measured and calculated on the basis of the method described in the Examples below.

The number average molecular weight Mn of the polyolefin-based resin is not particularly limited, but is preferably 1,000 or greater, and more preferably 2,000 or greater, and preferably 1,000,000 or less, and more preferably 500,000 or less.

The content of the polyolefin-based resin in the coating layer is not particularly limited, but is preferably 40 mass % or greater, more preferably 45 mass % or greater, even more preferably 48 mass % or greater, and particularly preferably 50 mass %.

Examples of the homopolymer of an olefin compound include homopolymers of α-olefin having from 2 to 20 carbons, such as polyethylene (e.g., low density polyethylene, medium density polyethylene, high density polyethylene, or linear low density polyethylene), polypropylene, polyisobutylene, poly(1-butene), poly(1-pentene), and poly(1-hexene).

Examples of the copolymer of an olefin compound include ethylene-propylene copolymers, ethylene-1-butene copolymers, ethylene-1-octene copolymers, and ethylene-1-hexene copolymers.

The polyolefin-based resin used may be a polyolefin-based resin containing an introduced polar group. Specific examples of the polyolefin-based resin containing an introduced polar group include acid-modified polyolefins, such as maleic anhydride-modified polyethylene, maleic acid-modified polyethylene, acrylic acid-modified polyethylene, maleic anhydride-modified polypropylene, maleic acid-modified polypropylene, maleic anhydride-modified ethylene-propylene copolymer, and acrylic acid-modified polypropylene; ethylene or α-olefin-vinyl monomer copolymers, such as ethylene-vinyl chloride copolymers, ethylene-vinylidene chloride copolymers, ethylene-acrylonitrile copolymers, ethylene-methacrylonitrile copolymers, ethylene-vinyl acetate copolymer, ethylene-acrylamide copolymers, ethylene-methacrylamide copolymers, ethylene-acrylic acid copolymers, ethylene-methacrylic acid copolymers, ethylene-maleic acid copolymers, ethylene-methyl (meth)acrylate copolymers, ethylene-ethyl (meth)acrylate copolymers, ethylene-isopropyl (meth)acrylate copolymers, ethylene-(meth)acrylate copolymers, ethylene-isobutyl (meth)acrylate copolymers, ethylene-2-ethylhexyl (meth)acrylate copolymers, ethylene-maleic anhydride copolymers, ethylene-ethyl acrylate-maleic anhydride copolymers, and ethylene-(meth)acrylic acid metal salt copolymers, ethylene-vinyl acetate copolymers and saponified products thereof, ethylene-vinyl propionate copolymers, ethylene-glycidyl (meth)acrylate copolymers, ethylene-ethyl acrylate-glycidyl methacrylate copolymers, and ethylene-vinyl acetate-glycidyl methacrylate copolymers; and chlorinated polyolefins, such as chlorinated polypropylene and chlorinated polyethylene.

### Additional Resin

As long as the effects of the present invention are not impaired, the coating layer may contain an additional resin besides the polyester-based resin.

As such an additional resin, a known resin used for coating layer formation can be used in accordance with a rubber or a resin for forming a hot-melt pressure sensitive adhesive layer provided on the coating layer described below.

Specific examples of such an additional resin include thermoplastic resins, such as acrylic resins, acrylic-modified polyolefin resins, chlorinated polyolefin resins, vinyl chloride-vinyl acetate copolymers, polyamide resins, and rubber-based resins; and thermosetting resins such as epoxy resin. One of these may be used alone, or two or more may be used in combination.

The content of such an additional resin in the coating layer is not particularly limited, but is preferably 20 mass % or less, more preferably 10 mass % or less, even more preferably 5 mass % or less, and particularly preferably 1 mass % or less, and the coating layer may not contain such an additional resin.

### Cross-Linking Agent

As long as the effects of the present invention are not impaired, the coating layer may contain a cross-linking agent.

Examples of the cross-linking agent include polyisocyanate compounds having two or more isocyanate groups per molecule. More specifically, examples include aromatic polyisocyanates, such as tolylene diisocyanate, diphenylmethane diisocyanate, and xylylene diisocyanate; alicyclic isocyanate compounds, such as dicyclohexylmethane-4,4′-diisocyanate, bicycloheptane triisocyanate, cyclopentylene diisocyanate, cyclohexylene diisocyanate, methylcyclohexylene diisocyanate, and hydrogenated xylylene diisocyanate; and aliphatic isocyanates, such as hexamethylene diisocyanate, trimethylhexamethylene diisocyanate, and lysine diisocyanate. One of these may be used alone, or two or more may be used in combination.

In addition, as the cross-linking agent, modified products of the polyisocyanate compounds described above can also be used, including biuret products or isocyanurate products, or adducts that are reaction products of these polyisocyanate compounds with a non-aromatic low molecular weight active hydrogen-containing compound, such as ethylene glycol, trimethylolpropane, or castor oil.

Examples of the cross-linking agent besides the polyisocyanate compound include a carbodiimide cross-linking agent, an oxazoline cross-linking agent, and an epoxy cross-linking agent.

The content of the cross-linking agent in the coating layer is not particularly limited, but is preferably 15 mass % or less, more preferably 10 mass % or less, and particularly preferably 8 mass % or less.

### Additional Additive

As long as the effects of the present invention are not impaired, the coating layer may contain an additional additive besides the cross-linking agent.

Such an additional additive can be appropriately selected based on the application of the coating layer, and examples thereof include fillers, pigments, colorants, metal powders, electrical conducting materials, softeners (plasticizers), surfactants, dispersants, neutralizers, thickeners, wetting agents, antifoaming agents, lubricants, antistatic agents, antiseptics, antioxidants, and ultraviolet absorbers. One of these may be used alone, or two or more may be used in combination.

The content of such an additional additive in the coating layer is not particularly limited, but is preferably 20 mass % or less, more preferably 10 mass % or less, even more preferably 5 mass % or less, and particularly preferably 1 mass % or less.

### Base Material

The base material can be appropriately selected based on the application of the pressure sensitive adhesive sheet, and examples thereof include resin films such as a polyester-based resin film, a polyolefin-based resin film, and synthetic paper, and paper base materials. Of these, a resin film is preferred.

The thickness of the base material is appropriately determined based on the application of the pressure sensitive adhesive sheet; however, from the viewpoints of handleability and economic efficiency, the thickness is preferably from 5 to 250 μm, more preferably from 15 to 200 μm, and particularly preferably from 25 to 150 μm.

The thickness of the base material is specifically a value measured and calculated on the basis of the same method as that for the thickness of the coating layer.

### Resin Film

Examples of the resin contained in the resin film include polyolefin-based resins, such as polyethylene, polypropylene, and ethylene-propylene copolymers; polyester-based resins, such as polyethylene terephthalate, polybutylene terephthalate, and polyethylene naphthalate; urethane-based resins, such as polyurethane and acrylic-modified polyurethane; vinyl-based resins, such as polyvinyl chloride, polyvinylidene chloride, polyvinyl alcohol, ethylene-vinyl acetate copolymers, and ethylene-vinyl alcohol copolymers; polystyrene resins; acrylonitrile-butadiene-styrene (ABS) resins; cellulose triacetate resins; polycarbonate resins; acetate resins; polyamide resins; and polyimide resins. Of these, a polyester-based resin is preferred, and the base material according to an embodiment of the present invention is preferably a resin film containing a polyester-based resin.

One of these may be used alone, or two or more may be used in combination. Furthermore, synthetic paper may be used as the resin film.

The content of the resin in the resin film is not particularly limited, but is preferably 80 mass % or greater, more preferably 90 mass % or greater, even more preferably 95 mass % or greater, and particularly preferably substantially 100 mass %.

The resin film may further contain an additive such as a filler, an ultraviolet absorber, a light stabilizer, an antioxidant, an antistatic agent, a slip agent, an anti-blocking agent, or a colorant, besides the resin described above.

The resin film may be a laminate including a plurality of laminated resin films or may be a foam.

### Metallized Layer

The metallized layer is not particularly limited, and examples thereof include a layer obtained by deposition of at least one of metal or a metal oxide.

Examples of the metal contained in the metallized layer include aluminum, zinc, tin, copper, nickel, chromium, silver, gold, iron, bismuth, titanium, indium, palladium, vanadium, tungsten, manganese, tantalum, and cobalt.

Examples of the metal oxide contained in the metallized layer include aluminum oxide, indium oxide, tin oxide, titanium oxide, silicon dioxide, antimony oxide, bismuth oxide, and zinc oxide.

In an aspect of the present invention, from the perspectives of capability of being used for various applications as well as excellence in cost and environmental aspects, the metallized layer preferably contains aluminum and is more preferably an aluminum-deposited layer.

The metallized layer may be a single metallized layer or may be a laminated film including a plurality of laminated metallized layers.

Examples of the method for forming the metallized layer on the base material include vacuum deposition, electron beam vacuum evaporation, PVD, sputtering, ion plating, thermal CVD, plasma CVD, and optical CVD.

In a case where a resin film is used as the base material, the surface of the resin film may be subjected to a surface treatment, such as an oxidation method or a roughening method for improving adhesion between the resin film and the metallized layer.

The oxidation method is not particularly limited, and examples thereof include corona discharge treatment, plasma treatment, chromium acid oxidation (wet type), flame treatment, hot-air treatment, and ozone-ultraviolet irradiation treatment.

The roughening method is not particularly limited, and examples thereof include a sandblasting method and a solvent treatment.

The thickness of the metallized layer is appropriately determined based on the application of the pressure sensitive adhesive sheet and is typically from 1 to 300 nm. The metallized layer containing a metal oxide may be a layer of a metal oxide itself, or may be a metallized layer obtained by forming an oxide film on a surface of a metal-containing metallized layer. The oxide film may be an oxide film naturally formed on a surface of the metallized layer or may be artificially formed by an electrochemical treatment.

### Hot-Melt Pressure Sensitive Adhesive Layer

The hot-melt pressure sensitive adhesive layer contains a rubber. The hot-melt pressure sensitive adhesive layer is formed by application of a heated and melted mixture containing a rubber and a thermoplastic resin such as acrylic or olefin resin. As necessary, a softener, a tackifying resin, or an additional additive may be incorporated.

In one aspect of the present invention, the hot-melt pressure sensitive adhesive layer is preferably a layer containing a tackifying resin.

The thickness of the hot-melt pressure sensitive adhesive layer is not particularly limited, but is preferably from 1 to 200 μm, more preferably from 5 to 150 μm, and particularly preferably from 10 to 100 μm.

The thickness of the hot-melt pressure sensitive adhesive layer is specifically a value measured and calculated on the basis of the same method as that for the thickness of the coating layer.

### Rubber

Examples of the rubber that may be contained in the hot-melt pressure sensitive adhesive layer include natural rubbers, such as RSS-No. 1 to 4, SMR-5L, SMR-20, and CV-60; and synthetic rubbers, such as styrene-isoprene-styrene block copolymer (SIS) rubbers, styrene-butadiene rubbers, butadiene rubbers, chloroprene rubbers, and nitrile rubbers. One of these may be used alone, or two or more may be used in combination.

Since many rubbers have high molecular weights, initial pressure sensitive adhesion and coatability are improved by mechanically reducing the molecular weight with a mixing roll, a Banbury kneader, or a kneader.

### Softener

The softener contained in the hot-melt pressure sensitive adhesive layer is to improve coatability by reducing the viscosity of the hot-melt pressure sensitive adhesive, and examples thereof include petroleum-based softeners, such as process oil and extender oil; plant oil-based softeners such as tall oil; and synthetic plasticizers such as dibasic acid ester-based plasticizers. One of these may be used alone, or two or more may be used in combination.

### Tackifying Resin

The tackifying resin (tackifier) that can be contained in the hot-melt pressure sensitive adhesive layer serves a role in enhancing initial tack and pressure sensitive adhesive force.

Examples of the tackifying resin include terpene resins, such as rosin-based resins, rosin-based resins esterified with pentaerythritol, polymers of terpenes, such as α-pinene and β-pinene, and copolymers of these; terpene modified products, such as terpene phenol resins; petroleum resins, such as aromatic hydrocarbon resins and aliphatic hydrocarbon resins (e.g., aliphatic/aromatic copolymer petroleum resins) and hydrides of these; and phenolic resins, such as coumarone-indene resins and alkylphenol-acetylene resins. One of these may be used alone, or two or more may be used in combination.

### Additional Additive

Examples of an additional additive that can be contained in the hot-melt pressure sensitive adhesive layer include fillers such as calcium carbonate and clay; pigments; and antioxidants. One of these may be used alone, or two or more may be used in combination.

Examples of the device for mixing the components described above include a Banbury kneader, a kneader, and a twin-screw kneading extruder. One of these may be used alone, or two or more may be used in combination.

In a case where the molecular weight of the rubber needs to be lowered, mixing of a softener, a tackifying resin, and an additional additive may be performed after lowering of the molecular weight of the rubber, or the mixing may be performed simultaneously at the time of lowering of the molecular weight of the rubber.

The temperature at the time of mixing is not particularly limited; however, from the perspective of homogeneity, the temperature is preferably not lower than the softening point of the tackifying resin, and from the viewpoint of prevention of deterioration of the rubber, the temperature is preferably 200° C. or lower.

### Release Liner

The release liner is typically formed on the hot-melt pressure sensitive adhesive layer on a side opposite to the coating layer side.

Examples of the release liner include a release sheet subjected to a double-sided release treatment and a release sheet subjected to a single-sided release treatment.

Examples of the release treatment include application of a release agent on a surface of a base material for a release liner.

Examples of the base material for a release liner include resin films, paper base materials, laminated paper, and synthetic paper, which can be used as base materials contained in pressure sensitive adhesive sheets. One of these may be used alone, or two or more may be used in combination.

Examples of the release agent include olefin-based resins, isoprene-based resins, butadiene-based resins, silicone-based resins, long-chain alkyl-based resins, alkyd-based resins, and fluorine-based resins. One of these may be used alone, or two or more may be used in combination.

The thickness of the release liner is not particularly limited, but is preferably from 10 to 200 μm, and more preferably from 25 to 150 μm.

The thickness of the release liner is specifically a value measured and calculated on the basis of the same method as that for the thickness of the coating layer.

### Printed Coating Layer

The printed coating layer is typically formed on the base material on a side opposite to the metallized layer side.

The resin material of the printed coating layer is not particularly limited as long as the resin material can form a printed coating layer having good adhesion to the base material and good adhesion of a printing ink. Examples thereof include acrylic resins, styrene-based resins, polyester urethane-based resins, polyester-based resins, polyurethane-based resins, polyol-based resins, polyvinyl alcohol, polyvinyl pyrrolidone, cellulose derivatives, acetate derivatives, polyvinyl chloride-based resins, and polyimide-based resins. One of these may be used alone, or two or more may be used in combination.

Among these, a polyester urethane resin is preferred. The polyester urethane resin may be appropriately polymerized by using a cross-linking agent or a cross-linking promoter.

In a case where the base material on which a printed coating layer is formed is a resin film such as synthetic paper, the content of the resin material in the printed coating layer is not particularly limited, but is preferably 80 mass % or greater, more preferably 90 mass % or greater, even more preferably 95 mass % or greater, and particularly preferably substantially 100 mass %.

Examples of the additive that can be added to the printed coating layer include pigments, colorants, metal powders, electrical conducting materials, softeners (plasticizers), solvents, surfactants, dispersants, neutralizers, thickeners, wetting agents, antifoaming agents, lubricants, antistatic agents, cross-linking agents, antiseptics, antioxidants, and ultraviolet absorbers. One of these may be used alone, or two or more may be used in combination.

The content of the additive in the printed coating layer is not particularly limited, but is preferably 20 mass % or less, more preferably 10 mass % or less, and even more preferably 5 mass % or less.

The thickness of the printed coating layer is not particularly limited, but is preferably from 10 to 600 nm, and more preferably from 30 to 200 nm.

The thickness of the printed coating layer is specifically a value measured and calculated on the basis of the same method as that for the thickness of the coating layer.

### Method for Producing Pressure Sensitive Adhesive Sheet

The method for producing a pressure sensitive adhesive sheet according to an embodiment of the present invention is a method for producing a pressure sensitive adhesive sheet including a base material, a metallized layer, a coating layer containing a polyester-based resin, and a rubber-based hot-melt pressure sensitive adhesive layer in this order, the method including forming a coating layer by application of a coating liquid having a pH of 5 to 9.

Since the coating layer is formed by application of a coating liquid having a pH of 5 to 9, the metallized surface is not corroded even after a long period of time from the production of the pressure sensitive adhesive sheet, and functions (e.g., flexibility, elasticity, and pressure sensitive adhesion) required for the pressure sensitive adhesive sheet can be adequately exhibited.

From the perspectives of suppressing corrosion of the metallized surface and achieving good adhesion between the metallized layer and the coating layer, the pH of the coating liquid is preferably 5.5 or higher, more preferably 6 or higher, and preferably 8.5 or lower, and more preferably 8 or lower.

The method for producing the pressure sensitive adhesive sheet is not particularly limited as long as the method includes a step of forming a coating layer by application of a coating liquid having a pH of 5 to 9, and a preferred embodiment of the method will be described below.

For example, the pressure sensitive adhesive sheet 1a of FIG. 1 can be produced by subjecting a base material 11 to a known deposition process with a material that can form a metallized layer, to thereby form a metallized layer 12, then applying a coating liquid that can form a coating layer containing the aforementioned polyester-based resin and that has a pH of 5 to 9 onto the metallized layer by a known coating process and drying the liquid, to thereby form a coating layer 13, and then further applying the hot-melt pressure sensitive adhesive described above onto the coating layer 13 by a known coating process, to thereby form a hot-melt pressure sensitive adhesive layer 14.

The pressure sensitive adhesive sheet 1b of FIG. 2 can be produced by laminating a release liner 15 on the hot-melt pressure sensitive adhesive layer 14 of the pressure sensitive adhesive sheet 1a of FIG. 1 produced by the method described above.

The pressure sensitive adhesive sheet 1b of FIG. 2 can be also produced by attaching the hot-melt pressure sensitive adhesive layer 14 formed on the release liner 15 by the method described above to the coating layer 13 formed on the base material 11 by the method described above.

Furthermore, a printed coating layer (not illustrated) may be formed on the base material 11 of the pressure sensitive adhesive sheet 1a of FIG. 1 or the base material 11 of the pressure sensitive adhesive sheet 1b of FIG. 2 produced by the method described above.

From the perspective of suppressing an effect on the environment and occurrence of adhesive residue, the method for producing the pressure sensitive adhesive sheet preferably includes a step of applying an aqueous coating liquid in which a polyester-based resin is dispersed in water and which has a pH of 5 to 9 to a base material. The water-based coating liquid in which the polyester-based resin is dispersed in water may contain a solvent described below. One type of such a solvent may be used alone, or two or more types of such solvents may be used. Preferably, the coating liquid does not contain such a solvent.

In a case where the coating layer further contains at least one of a polyurethane-based resin or a polyolefin-based resin, a step of applying an aqueous coating liquid in which a polyester-based resin and at least one of a polyurethane-based resin or a polyolefin-based resin are dispersed in water and which has a pH of 5 to 9 to the base material is preferably included.

In a case where the coating layer is formed by application of the aqueous coating liquid to the base material, a small amount of an emulsifying agent or a surfactant may be used for dispersing the polyester-based resin in water, as long as the effects of the present invention are not impaired.

However, a low molecular weight component such as an emulsifying agent or a surfactant may be localized in the coating layer, and thus may cause a reduction in adhesion, resulting in impaired interlayer adhesion. Consequently, this tends to cause a phenomenon in which adhesive residue on an adherend occurs when the pressure sensitive adhesive sheet is peeled from the adherend or a phenomenon in which the pressure sensitive adhesive layer oozes out at the time of cutting of the pressure sensitive adhesive sheet.

From the perspective of suppressing these phenomena, in an aspect of the present invention, the polyester-based resin is preferably a self-emulsifying polyester-based resin.

In a case of a self-emulsifying polyester-based resin, an emulsion can be formed without using a low molecular weight component such as an emulsifying agent or a surfactant, which may cause a reduction in interlayer adhesion, the resulting pressure sensitive adhesive sheet can be provided with further improved interlayer adhesion. Furthermore, the pressure sensitive adhesive sheet has an excellent effect of suppressing oozing of the pressure sensitive adhesive layer at the time of cutting.

The term “self-emulsifying” means that a resin has any hydrophilic group chemically introduced into its skeleton, and the resin itself has emulsification capacity without need for addition of an emulsifying agent or a surfactant.

Examples of the solvent that may be contained in the aqueous coating liquid include methanol, ethanol, propanol, butanol, isopropyl alcohol, dimethylacetamide, ethylene glycol, ethylene glycol, ethylene glycol mono-n-propyl ether, propylene glycol monomethyl ether, and propylene glycol monomethyl ether acetate. One of these may be used alone, or two or more may be used in combination.

Furthermore, from the perspectives of achieving good coatability and improving working efficiency, the material that can form the printed coating layer may be applied onto the base material in a form of a solution obtained by adding a solvent to the material, or may be applied in a form of a dispersion in which the material is dispersed in water.

The solvent is not particularly limited and is appropriately selected based on the type of the material that can form the printed coating layer described above.

Examples of the coating method of the material that can form the printed coating layer and the material that can form the coating layer include spin coating, spray coating, bar coating, knife coating, air knife coating, roll knife coating, roll coating, blade coating, die coating, gravure coating, lip coating, and curtain coating.

Examples of the coating method of the raw material that can form the hot-melt pressure sensitive adhesive layer include spray coating, bar coating, knife coating, air knife coating, roll knife coating, roll coating, blade coating, die coating, gravure coating, lip coating, and curtain coating.

The drying temperature and the drying time of the coating formed after application of the coating layer and the printed coating layer are not particularly limited and can be appropriately determined.

### EXAMPLES

The present invention will be described in more detail with reference to Examples below, but the present invention is not limited to the following Examples.

Physical property values of resins contained in the coating layer below (polyester-based resin, polyurethane-based resin, and polyolefin-based resin) are values measured by the following methods.

Pressure sensitive adhesive sheets produced in Examples and Comparative Examples were evaluated for the following “metallized layer/coating layer adhesion”, “removability”, and “appearance after hygrothermal aging” were evaluated. The results are shown in Table 1.

### (1) Glass Transition Temperature (Tg) of Resin

The glass transition temperature (° C.) of the resin used for forming a barrier layer was measured using a differential scanning calorimeter (product name “DSC Q2,000”, available from TA Instruments Japan Inc.) at a temperature increase rate of 20° C./min in accordance with JIS K 7121 (2012).

### (2) Softening Point of Resin

The softening point (° C.) of the resin used for forming the barrier layer was measured according to the softening point test method (ring and ball method) specified in JIS K 5601-2-2 (1999).

### (3) Hydroxyl Value of Resin

The hydroxyl value (KOHmg/g) of the resin used for forming the barrier layer was measured in accordance with JIS K 0070 (1992).

### (4) Acid Value of Resin

The acid value (KOHmg/g) of the resin used for forming the barrier layer was measured in accordance with JIS K 0070 (1992).

### (5) Metallized Layer/Coating Layer Adhesion

Each of the pressure sensitive adhesive sheets produced in Examples and Comparative Examples was evaluated for adhesion at an interface between the metallized layer and the coating layer based on the following criteria in accordance with JIS K 5600 May 6 (1999).
◯: Classification by JIS K 5600-5-6 (1999) is “0 (best)” to “1”.
x: Classification by JIS K 5600-5-6 (1999) is “2” to “5”.

### (6) Removability

Each of the pressure sensitive adhesive sheets produced in Examples and Comparative Examples was cut into a size of 25 mm×50 mm in an environment at 23° C. and 50% RH (relative humidity), to thereby prepare two test pieces (I). The release sheet of each of the test pieces (I) was removed, and the exposed pressure sensitive adhesive layer was attached to the following adherend.
Stainless steel (SUS) sheet

The test pieces (I) attached to the adherend were allowed to stand still in an environment at 23° C. and 50% RH (relative humidity) for 7 days, and then one of the test pieces (I) was peeled from the adherend with hands at a speed of approximately 300 mm/min in a 180° direction (low-speed peeling) and the other one was peeled with hands at a speed of approximately 30 m/min in a 180° direction (high-speed peeling).

Then, the state of each of the layers of the test piece (I) was visually observed after the peeling, and the interlayer adhesion of the pressure sensitive adhesive sheet (removability) was evaluated based on the following criteria.
A: Peeling occurred between the pressure sensitive adhesive layer and the adherend, and no pressure sensitive adhesive layer remained on the adherend, and thus removability was excellent.
B: Peeling occurred happened between the metallized layer and the coating layer, and remaining of the coating layer and the pressure sensitive adhesive layer was observed on the adherend.
C: Peeling occurred between the coating layer and the pressure sensitive adhesive layer, and remaining of the pressure sensitive adhesive layer was observed on the adherend.
D: Peeling occurred between the metallized layer and the pressure sensitive adhesive layer, and remaining of the pressure sensitive adhesive layer was observed on the adherend.
   (7) Appearance after Hygrothermal Aging

Each of the pressure sensitive adhesive sheets produced in Examples and Comparative Examples was allowed to stand still in an environment at 60° C. and 95% RH (relative humidity) for 7 days, and the appearance was visually observed and evaluated based on the following criteria.
◯: No significant change was observed.
Δ: The metallized layer was corroded, and a few transparent portions were observed on the metallized layer.
x: The metallized layer was corroded, and many transparent portions were observed on the metallized layer.

The aqueous resin 1 dispersion and the aqueous resin 2 dispersion used in the Examples and Comparative Examples are as follows. The glass transition temperature, the softening point, the hydroxyl value, and the acid value were values measured by the methods described in (1), (2), (3), and (4) above.
(i) “Polyester resin” (glass transition temperature: 46° C.; hydroxyl value: 5 KOHmg/g; acid value: 50 KOHmg/g)
(ii) “Polyurethane-based resin” (glass transition temperature: 85° C.; acid value: 18 KOHmg/g)
(iii) “Polyolefin-based resin” (softening point: 40° C.)

### Example 1

There was used aluminum (Al)-deposited PET film “Metalumy TS” (available from Toray Industries, Inc., thickness: 50 μm) including a polyethylene terephthalate film as a base material and a metallized layer deposited on the film.

Onto the aluminum-deposited surface of the base material, an aqueous resin dispersion for coating layer formation prepared by dispersing “polyester resin” (glass transition temperature: 46° C., hydroxyl value: 5 KOHmg/g, acid value: 50 KOHmg/g) in water and having a solid content concentration of 10 mass % and a pH of 7 was applied, to thereby form a coating film. The coating film was then dried at 90° C. for 1 minute, to form a coating layer having a thickness of 1 μm.

Then, a synthetic rubber-based hot-melt pressure sensitive adhesive composition “TOYOMELT P-708K-5” (available from Toyo ADL Corporation) melted at 150° C. was applied with a die coater onto a release liner (produced by application of a silicone-based release agent on a polyethylene terephthalate base material, thickness: 50 μm), to form a hot-melt pressure sensitive adhesive layer having a thickness of 20 μm. Subsequently, the coating layer and the hot-melt pressure sensitive adhesive layer were laminated, to produce a pressure sensitive adhesive sheet.

The produced pressure sensitive adhesive sheet was evaluated for metallized layer/coating layer adhesion, removability, and appearance after hygrothermal aging. The evaluation results are shown in Table 1 below.

### Examples 2 and 3

A pressure sensitive adhesive sheet was produced in the same manner as in Example 1 except that the aqueous resin dispersion used in Example 1 was replaced with an aqueous resin dispersion for coating layer formation prepared by mixing the aqueous resin 1 dispersion and the aqueous resin 2 dispersion in a mass proportion of 1:1 and having a solid content concentration of 10 mass % and a pH shown in Table 1 below. The pressure sensitive adhesive sheet was evaluated for metallized layer/coating layer adhesion, removability, and appearance after hygrothermal aging. The results are shown in Table 1. The pH of the aqueous resin dispersion for coating layer formation used in Example 2 was 7.5, and the pH of the aqueous resin dispersion for coating layer formation used in Example 3 was 8.5.

### Comparative Example 1

A pressure sensitive adhesive sheet was produced in the same manner as in Example 1 except that a hot-melt pressure sensitive adhesive layer was formed directly on the aluminum-deposited surface of the base material without forming a coating layer. The pressure sensitive adhesive sheet was evaluated for metallized layer/coating layer adhesion, removability, and appearance after hygrothermal aging. The results are shown in Table 1.

### Comparative Examples 2 and 3

A pressure sensitive adhesive sheet was produced in the same manner as in Example 1 except that the aqueous resin 1 dispersion used in Example 1 was replaced with an aqueous resin 1 dispersion having a pH shown in Table 1 below. The pressure sensitive adhesive sheet was evaluated for metallized layer/coating layer adhesion, removability, and appearance after hygrothermal aging. The results are shown in Table 1.

### [Table 1]

TABLE 1

| | Coating layer | | | | | | | | |
|---|---|---|---|---|---|---|---|---|---|
| | | | Dispersion | | | Evaluation results | | | |
| | | | for coating | | | Metallized | Removability | | Appearance |
| | Aqueous resin | Aqueous resin | layer | | | layer/coating | Low- | High- | after |
| | 1 dispersion | 2 dispersion | formation | Thickness | Base | layer | speed | speed | hygrothermal |
| | Type | Type | pH | (μm) | material | adhesion | peeling | peeling | aging |
| Example 1 | Polyester resin | — | 7 | 1 | PET | ∘ | A | C | ∘ |
| Example 2 | Polyester resin | Polyurethane resin | 7.5 | 1 | film | ∘ | A | A | ∘ |
| Example 3 | Polyester resin | Polyolefin resin | 8.5 | 1 | | ∘ | A | A | Δ |
| Comparative | — | | | | | — | D | D | ∘ |
| Example 1 | | | | | | | | | |
| Comparative | Polyurethane | — | 8 | 1 | | x | B | B | ∘ |
| Example 2 | resin | | | | | | | | |
| Comparative | Polyolefin | — | 10 | 1 | | x | B | B | x |
| Example 3 | resin | | | | | | | | |

As is clear from Table 1, occurrence of adhesive residue at the time of peeling can be suppressed by disposing the coating layer containing a polyester-based resin between the metallized layer and the hot-melt pressure sensitive adhesive layer.

### INDUSTRIAL APPLICABILITY

The pressure sensitive adhesive sheet according to an embodiment of the present invention can be used as a pressure sensitive adhesive sheet in a wide variety of applications, including labels for display, labels for decoration, packaging films, window films, labels for electromagnetic shielding, packaging, and sheets for electrical equipment.

### REFERENCE SIGNS LIST

1a, 1b Pressure sensitive adhesive sheet
11 Base material
12 Metallized layer
13 Coating layer
14 Hot-melt pressure sensitive adhesive layer
15 Release liner

1. A pressure sensitive adhesive sheet, comprising:
a base material, a metallized layer, and a rubber-based hot-melt pressure sensitive adhesive layer in this order, and
a coating layer disposed between the metallized layer and the rubber-based hot-melt pressure sensitive adhesive layer and containing a polyester-based resin.

2. The pressure sensitive adhesive sheet according to claim 1, wherein the coating layer further contains at least one of a polyurethane-based resin or a polyolefin-based resin.

3. The pressure sensitive adhesive sheet according to claim 1, wherein the metallized layer is an aluminum-deposited layer.

4. The pressure sensitive adhesive sheet according to claim 1, wherein the base material is a resin film containing a polyester-based resin.

5. The pressure sensitive adhesive sheet according to claim 1, wherein the polyester-based resin contained in the coating layer has a glass transition temperature of from 20 to 80° C.

6. The pressure sensitive adhesive sheet according to claim 1, further comprising a release liner on the rubber-based hot-melt pressure sensitive adhesive layer on a side opposite to the coating layer.

7. A method for producing a pressure sensitive adhesive sheet, the method comprising:
forming a coating layer containing a polyester-based resin by applying a coating liquid having a pH of 5 or higher and 9 or lower,
wherein the pressure sensitive adhesive sheet comprises a base material, a metallized layer, the coating layer, and a rubber-based hot-melt pressure sensitive adhesive layer in this order.
